(19) United States
(12) Patent Application Publication
(10) Pub. No.: US 2020/0371616 A1
(43) Pub. Date: Nov. 26, 2020

(54) Wireless Multi-Touch Device Systems and Methods

(71) Applicant: Brydge Global Pte Ltd., Park City, UT (US)

(72) Inventors: Nicholas James Smith, Park City, UT (US); Toby Mander-Jones, Park City, UT (US)

(21) Appl. No.: 16/417,303

(22) Filed: May 20, 2019

(51) Int. Cl. G06F 3/044; H04W 4/80; G06F 3/023; G06F 3/0354

(52) U.S. Cl. CPC G06F 3/044; H04W 4/80; G06F 2203/04101; G06F 3/03547; G06F 2203/04104; G06F 3/0231

(57) ABSTRACT

Transparent displays with capacitive touch are disclosed herein. Some embodiments a method includes scaling multi-touch input generated by a multi-touch device based on a network limitations of a wireless protocol of a wireless connection; assembling a multiplexed signal comprising the scaled multi-touch input; and transmitting the multiplexed signal to a computing device through the wireless connection.

### FIELD OF THE INVENTION

The present disclosure relates generally to wireless multi-touch device systems and methods, and more particularly, but not by limitation, to multi-touch wireless systems that provide full multi-touch functionality to an operating system over a wireless connection, where the multi-touch input are scaled based on network limitations of a wireless protocol to reduce latency and allow for customizable features of the multi-touch device.

### SUMMARY

According to some embodiments, the present disclosure is directed to a system, comprising: a communications interface configured to transmit data over a wireless connection using a wireless protocol having defined network limitations; a processor; and a memory for storing executable instructions, the processor executing the instructions to: scale multi-touch input (e.g., report inputs) generated by a multi-touch device based on the network limitations; and transmit the scaled multi-touch input to a computing device that is capable of being communicatively coupled to the processor through the communications interface.

According to some embodiments, the present disclosure is directed to a method, comprising: scaling multi-touch input generated by a multi-touch device based on a packet size of data packets of a wireless protocol of a wireless connection; assembling a multiplexed signal comprising the scaled multi-touch input and the palm signal; and transmitting the multiplexed signal to a computing device through the wireless connection.

According to some embodiments, the present disclosure is directed to a method, comprising: scaling a plurality of signals generated by a multi-touch device based on a packet size of data packets delivered through a human interface device (HID) protocol, the packet size is based on a wireless communications protocol of a wireless connection; multiplexing the plurality of report inputs into the data packets of a single HID signal; and transmitting the data packets of the single HID signal to an operating system over a wireless network connection using the wireless communications protocol.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a schematic view of an example system that comprises a multi-touch system that is wireless communication with a computing device.

FIG. 2 is a schematic view of another example system that comprises a multi-touch system that is wireless communication with a computing device, the multi-touch system comprising a keyboard.

FIG. 3 is a flowchart of an example method of the present disclosure.

FIG. 4 is a flowchart of another example method of the present disclosure.

FIG. 5 is a schematic diagram of an example computer device or system that can be used to practice aspects of the present disclosure.

### DETAILED DESCRIPTION

### Overview

In computing, a multi-touch digitizer is a technology that enables a trackpad or touchscreen to recognize more than one, or more than two, points of contact with a touch surface. In general, the touch surface of the multi-touch device can be considered as a grid. In order for a trackpad (or touchpad) to be able to deliver a true multi-touch user experience, the multi-touch device requires the following usages: X and Y position, tip, scan time and in-range. Additionally, the following usages are optional depending on the implementation; width and height, confidence, pressure, barrel, x-tilt, y-tilt, twist, and azimuth. For example, a position of each finger touching the multi-touch device is defined by x and y Cartesian coordinates relative to the grid of the touch surface of the multi-touch device. The p-value relates to a pressure of the finger sensed by the multi-touch device.

Correspondingly, the operating system of the computing device is configured to interpret these multi-touch data and transform the multi-touch data into multi-touch gestures within the operating system. These multi-touch gestures are used to control on-screen actions. The operating system is also configured to interpret any data points created by a palm of the hand and interpret those inputs as a negative result, effectively subtracting out the effect of the palm on the surface of the multi-touch device.

Modern laptops that incorporate or integrate trackpads (e.g., Windows™, MacOS™ and Chrome OS™) all operate in a similar manner and in doing so deliver a fully customizable experience to the user vis-a-vis an ability to tune different features such as pointer speed, scrolling speed and direction, as well as providing custom gestures like three finger swipe up and/or down to various on-screen actions in the operating system. Laptops can achieve this experience because the trackpads are physically wired into a mainboard of the laptop, meaning that any communication is not limited via bandwidth.

While wireless trackpads exist in market none natively operate as a true multi-touch trackpad, such as a trackpad that is integrated into the computer. Current trackpads manage the computation of all multi-touch gestures on a mainboard of the trackpad and not within the operating system of the computer itself. Currently, wireless trackpads and other multi-touch devices provide a limiting experience whereby the trackpad pairs to the operating system as a traditional mouse which in turn limits a number of customizable features available to the user.

Stated otherwise, current systems cannot deliver a true multi-touch device experience wirelessly due to the limiting bandwidth of either Bluetooth or Wireless 2.4 GHz technology used to couple the multi-touch device with an operating system of a computing device. These issues are further compounded when delivering a keyboard and multi-touch experience via a single wireless connection using the Human Interface Device (HID) protocol, as the bandwidth available is not stable enough to provide a seamless user experience. Again, a typical multi-touch device generates multi-touch input that are too numerous or large to fit into the bandwidth available in a Bluetooth or Wireless 2.4 GHz connection. More specifically, the packet size data packets used in the Bluetooth or Wireless 2.4 GHz connection are not sized sufficiently to transmit all the data included in the multi-touch input. A poor user experience may be created when excessive multi-touch signal data are transmitted over the Bluetooth or Wireless 2.4 GHz connection, which creates latency. For example, a scrolling action rendered by the operating system of the computing device may be viewed as choppy or delayed. Existing systems and devices have attempted to remedy these issues by eliminating portions (even significant portions) of the multi-touch input, essentially creating HID signals that appear to be produced by a mouse peripheral.

That is, instead of using all the data generated by a multi-touch device such as an X position, a Y position, a scan time value, an in-range value, a width value, a height value, a confidence value, a left click indication, a right click indication, a pressure value, a barrel value, an X tilt value, a Y tilt value, an azimuth value, the operating system arbitrarily alters these data to an X position, a Y position, and both right and left click. Thus, the robust nature of the multi-touch data is lost when the operating system alters these data. The data of the multi-touch data are too large to be effectively transmitted over a wireless connection, which causes the operating system to ignore numerous parameters of the multi-touch data.

Thus, existing wireless trackpad solutions are configured to reduce the report usages (e.g., multi-touch input(s)) to a minimum amount required under the HID protocol to deliver a mouse experience. The HID signal received by the operating system of the computer is not a true multi-touch device input. Thus, the operating system of the computer recognizes the multi-touch device as a mouse, rather than a multi-touch device. In sum, the robust features of the multi-touch device become truncated due to the limited bandwidth of the wireless network connection leading to reduced user experience. Because of these limitations, the report usages transmitted to the operating system are reduced at the printed circuit board assembly (PCBA) level to a minimum required by the HID protocol to deliver a mouse experience.

In contrast, the present disclosure includes wireless multi-touch devices and methods that provide a more complete and robust user experience. In some embodiments, an example wireless multi-touch device is configured to determine attributes or parameters of a wireless network protocol used to couple the wireless multi-touch device with an operating system of a computing device. The attributes or parameters are indicative of network limitations of the wireless connection, as defined by the wireless protocol. In some embodiments, the network limitation relates to a packet size of data packets that can be transmitted over the wireless connection. In one or more embodiments, the wireless multi-touch device can be configured to scale a plurality of multi-touch input generated by the multi-touch device based on a packet size of data packets used in the wireless network protocol. Some embodiments allow for the multi-touch devices of the present disclosure to utilize Bluetooth or 2.4 GHz WiFi protocols, but the present disclosure can be adapted to other wireless network protocols. After scaling, the plurality of multi-touch input are assembled or multiplexed into a single human interface device (HID) signal, message, or data flow that is transmitted to the operating system of the computing device over the wireless network protocol. In some embodiments, the wireless multi-touch device is not physically integrated with the computing device but can be a standalone device. In some embodiments, the wireless multi-touch device is combined with a keyboard assembly and provided in a single housing or enclosure.

### Descriptive Embodiments

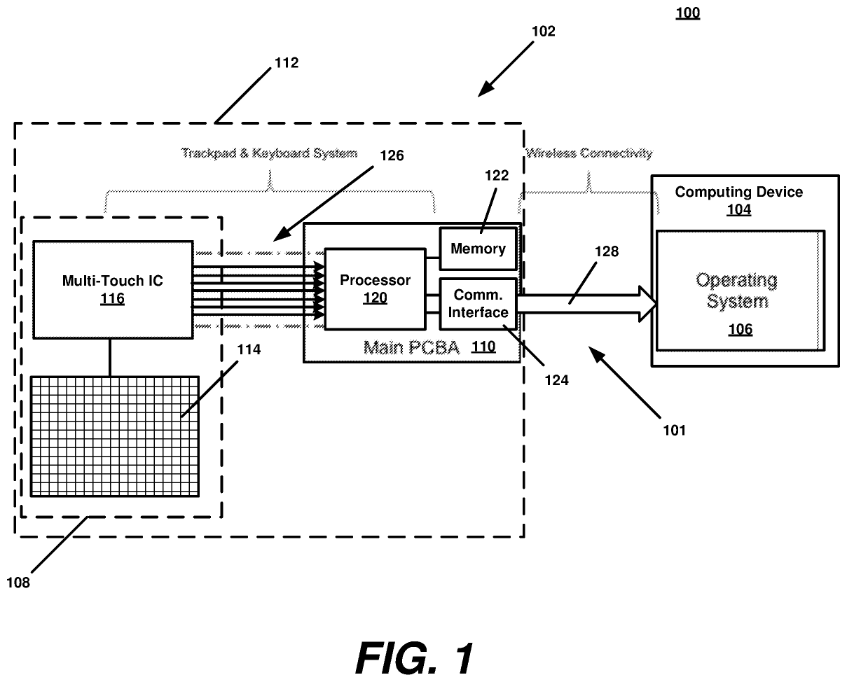

FIG. 1 is a schematic view of an example system 100 that comprises a multi-touch system 102 that is wireless communication with a computing device 104. In some embodiments, the multi-touch system 102 is in wireless communication with an operating system 106 of the computing device 104. Generally, the multi-touch system 102 comprises a multi-touch device 108 and a controller or main printed circuit board assembly (main PCBA 110). The multi-touch device 108 and the main PCBA 110 can be integrated into a housing 112 together in some embodiments. The multi-touch system 102 can communicatively couple with the operating system 106 of the computing device 104 over a wireless connection 101. As noted throughout, the wireless connection 101 can include any wireless connection such as a Bluetooth connection, a Bluetooth low-energy connection, a WiFi connection (2.4 GHz or 5 GHz), and near-field—just to name a few.

According to some embodiments, the multi-touch device 108 can comprise any suitable device such as a trackpad, a touchpad, or other similar surfaces that are configured to receive a plurality of multi-touch input, or report usages from a hand of a user. As noted above, the multi-touch device 108 can be configured to receive multi-touch input (also referred to as a report input) from a plurality of fingers of the hand of the user, as well as palm input. The multi-touch input could include a two finger pinch, swipe, drag or other similar input. Another example could include a three finger gesture. The palm input is received when the user's palm contacts the touch surface of the multi-touch device 108. In various embodiments, the palm input is a signal that is removed from by the operating system 106 of the computing device 108, as will be discussed in greater detail herein.

A touch surface of the multi-touch device 108 has a shape, such as a rectangular shape that defines a touch area, which is illustrated in FIG. 1 as a grid touch surface 114. The grid touch surface 114 can be combined with the multi-touch device 108 in a single housing in some embodiments. The touch surface is not specifically provided with a grid pattern, but is illustrated as such to define the X and Y position where each finger may occur.

When more than one finger is used by the user on the multi-touch device 108, a plurality of multi-touch input 126 can be generated by a multi-touch integrated circuit (IC) 116 of the multi-touch device 108. Signals may also be reported due to palm contact with the grid touch surface 114. The touch signals are interpreted by the operating system, which in turn interprets gestures and accurately implements palm rejection, as would be known to one or ordinary skill in the art.

According to some embodiments, each finger can create input or report usage that can comprise any of: an X position of the finger relative to the grid touch surface 114, a Y position of the finger relative to the grid touch surface 114, a scan time value, an in-range value, a width value, a height value, a confidence value, a left click indication, a right click indication, a pressure value, a barrel value, an X tilt value, a Y tilt value, an azimuth value, or any combinations thereof. Thus, the multi-touch input 126 includes the individual input or usage reported for each finger in contact with the grid touch surface 114 (as well as other incidental usage by the palm, if present).

The multi-touch integrated circuit 116 generates the multi-touch input 126 according to a refresh rate. Generally, the refresh rate refers to how often the multi-touch input 126 are updated by the multi-touch integrated circuit 116. As the refresh rate increases, a volume of data of the multi-touch input 126 increases. When the refresh rate is too high, the volume of data of the multi-touch input 126 increases to a point that the multi-touch input 126 cannot be efficiently or effectively transmitted over the wireless connection 101. While refresh rates have been used as an example multi-touch signal attribute or parameter that can be used as a reference, other multi-touch signal attributes or parameters could also be considered.

Each type of wireless protocol may have one or more network limitations. For example, a wireless protocol may specify a packet size for data packets transmitted using the wireless protocol, which is a packet limitation. In one example, the packet size of the wireless protocol defines, in part, the available bandwidth of the wireless connection 101. Moreover, the wireless protocol used to communicatively couple a wireless peripheral, such as a multi-touch device, to a computing device can be used to facilitate a human interface device (HID) connection that communicatively couples a peripheral I/O device to a physical or virtual port of an operating system of a computer. While packet size is described as an example network limitation, other wireless network limitations may also be utilized.

As noted above, the available bandwidth of the wireless connection 101 may be insufficient to transmit a volume of data found in the multi-touch input 126 created by the multi-touch integrated circuit 116. For example, a packet size of data packets of the HID signal that are received by the operating system 106 of the computing device 108 over the wireless connection 101 may be insufficient to transmit the complete volume of data of the multi-touch input 126. If the volume of data of the multi-touch input 126 were forcibly transmitted over the wireless connection 101, limitations of the wireless connection 101 may cause latency. In one example, a user is utilizing the multi-touch device 108 to provide a multi-touch gesture used to scroll through a web page provided on a web browser. The web browser can be provided by the computing device 108. Thus, the multi-touch input 126 generated by the multi-touch device 108, which are transmitted over the wireless connection 101 may cause latency in the scrolling operation if the volume of data of the multi-touch input 126 exceeds the available bandwidth of the wireless connection 101. For example, the volume of data of the multi-touch input 126 may not fit into the data packets (e.g., due to a sizing mismatch) that can be transmitted over the wireless connection 101, due to a packet size issue. In one example, the packet size may be in a range of hundreds of bytes, while the multi-touch input 126 may comprise thousands of bytes of data due to the refresh rate used by the computer 104. To remedy these issues, the multi-touch system 102 comprises a main PCBA 110 (printed circuit board assembly) that comprises a processor 120 and a memory 122. The memory stores executable instructions. The processor 120 can execute the instructions stored in memory 122 to perform any of the methods disclosed herein. The main PCBA 110 also comprises a communications interface 124 that allows the multi-touch system 102 to communicatively couple with the operating system 106 of the computing device 104 using the wireless connection 101.

According to some embodiments, the main PCBA 110 can determine the packet size of packets allowed based on the wireless protocol used by the wireless connection 101. Once the packet size is known, the main PCBA 110 can scale attributes or parameters of the multi-touch input 126 such that a size or volume of the multi-touch input 126 corresponds to the packet size of the wireless connection 101. To be sure, the scaling performed by the main PCBA 110 may vary as the available bandwidth of packet size of the wireless connection 101 varies. For example, a packet size of a Bluetooth connection may be different from a packet size of the 2.4 GHz WiFi connection. According to some embodiments, the main PCBA 110 can scale the multi-touch input 126 by selectively reducing a refresh rate of the multi-touch input 126 captured by the multi-touch integrated circuit 116. For example, the refresh rate could be modified such that the multi-touch integrated circuit 116 obtains multi-touch input every second rather than every tenth of a second. This process effectively reduces a volume or overall data of the multi-touch input 126.

Once the multi-touch input 126 have been scaled, the main PCBA 110 can assemble or multiplex the scaled multi-touch input 126 into a single HID signal 128 that is transmitted over the wireless connection 101. In some embodiments, all data points generated by the multi-touch device 108 are transmitted to the operating system 106 within the available bandwidth of the wireless technology utilized by the wireless connection 101, which is enabled due to the scaling available through the main PCBA 110. This provides a user of the computing device 104 to use the full features of the multi-touch system 102 without experiencing any delay or latency. Because all data generated by the multi-touch device 108 is utilized, customizable features of the multi-touch device are available to a user. As noted above, if the operating system 106 cannot recognize the multi-touch device as a multi-touch device, but instead determines the multi-touch device to be a mouse, the operating system will not allow the user to specific customizable features for a multi-touch device. Because all data generated by the multi-touch device 108 is transmitted to the operating system, the operating system 106 can identify the multi-touch input 126 and recognize the multi-touch system 102 as a multi-touch peripheral. The customizable features comprise any one or a combination of a pointer speed, a scrolling speed, a scrolling direction, or custom gestures —just to name a few. In turn, the operating system 106 of the computing device 104 can apply the customizable features to on-screen actions in the operating system 106 (for example, the scrolling use case provided above). As noted above, the operating system 106 can facilitate palm rejection of any portion of the multi-touch signals that are indicative of a palm input of a user.

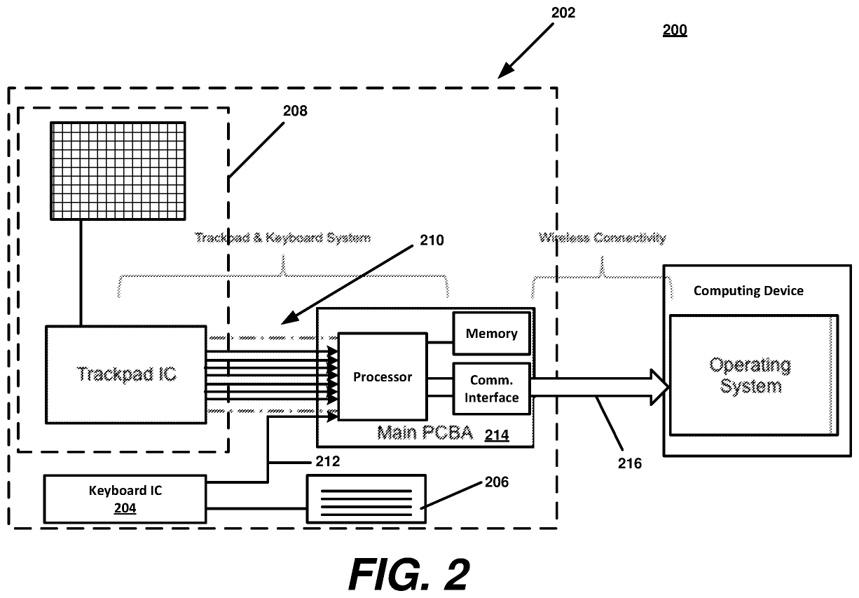

FIG. 2 is a schematic view of an example system 200 that is configured similarly to the example system 100 of FIG. 1, with the exception that a multi-touch system 202 includes a keyboard integrated circuit 204 and keyboard 206. In some embodiments, the keyboard 206 is integrated together with a multi-touch device 208. In various embodiments, a plurality of multi-touch input 210 are combined with a keyboard signal 212 generated by the keyboard integrated circuit 204. A main PCBA 214, which is similar to the main PCBA 110 of FIG. 1, can be configured to scale and multiplex the plurality of multi-touch input 210 with the keyboard signal 212 to generate a single HID signal 216.

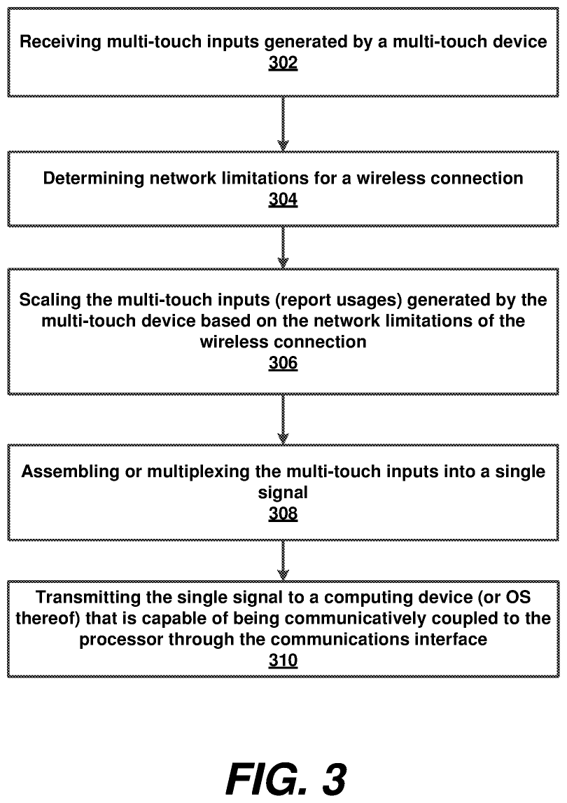

FIG. 3 is a flowchart of an example method of the present disclosure. The method generally includes a step 302 of receiving multi-touch input generated by a multi-touch device. Next, the method can comprise a step 304 of determining a packet size of data packets for a wireless connection. This can include, alternatively, a packet size of data packets for an HID protocol used to couple a wireless peripheral device with a computer. Once the packet size or available bandwidth is determined for the wireless connection, the method can include a step 306 of scaling the multi-touch input (collectively referred to as multi-touch input) generated by the multi-touch device based on a packet size of data packets of the wireless connection. In some embodiments, this scaling includes selecting a refresh rate for obtaining multi-touch input so that a volume of data of the multi-touch input substantially corresponds with the packet size or available bandwidth of the wireless connection. That is, the refresh rate used to collect the multi-touch input is scaled such that the volume of data included in the multi-touch input corresponds to the packet size or available bandwidth of the wireless connection.

Next, the method can include a step 308 of assembling or multiplexing the multi-touch input into a single signal. In some embodiments, this includes placing the multi-touch input into data packets according to an HID protocol. Once the single multiplexed signal is created, the method can include a step 310 of transmitting the single signal to a computing device that is capable of being communicatively coupled to the processor through the communications interface. The computing device will recognize the multi-touch device as an actual multi-touch device despite the fact that a single HID signal is used. That is rather than recognizing the multi-touch device as a mouse and/or adapting the multi-touch input into a form that provides mouse functionality, the operating system can use the full and robust data of the multi-touch input to enable multi-touch gesture functionality on the computing device.

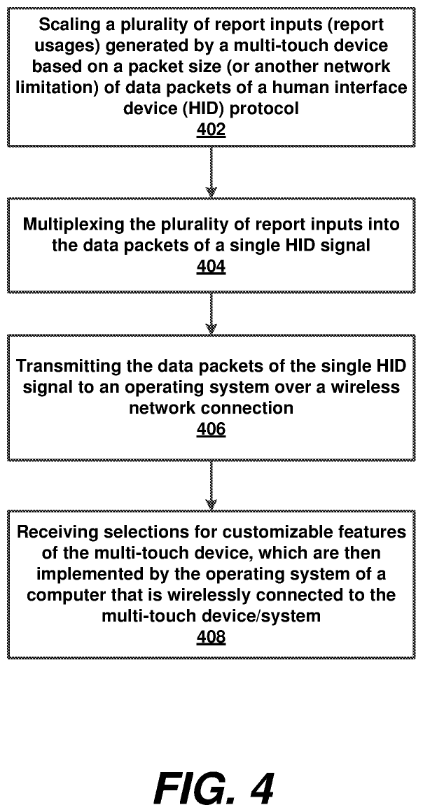

FIG. 4 is a flowchart of another example method of the present disclosure. The method includes a step 402 of scaling a plurality of report inputs (also referred to as report usages or multi-touch input) generated by a multi-touch device based on a packet size of data packets of a human device interface (HID) protocol. To be sure, the packet size being based on a wireless communications protocol of a wireless connection. Also, the plurality of report inputs includes multi-touch input from the fingers of a user, as well as palm input created when a palm of the user contacts the multi-touch device. Next, the method includes a step 404 of multiplexing the plurality of report inputs into the data packets of a single HID signal, as well as a step 406 of transmitting the data packets of the single HID signal to an operating system over a wireless network connection. The method can also include a step 408 of receiving selections for customizable features of the multi-touch device. The received selections are single or multi-touch input received through the multi-touch device based on options that can be displayed on the computing device that is wirelessly connected to the multi-touch device.

The operating system applies the customizable features to on-screen actions in the operating system. Examples of customizable features include, but are not limited to, any one or a combination of a pointer speed, a scrolling speed, a scrolling direction, or custom gestures.

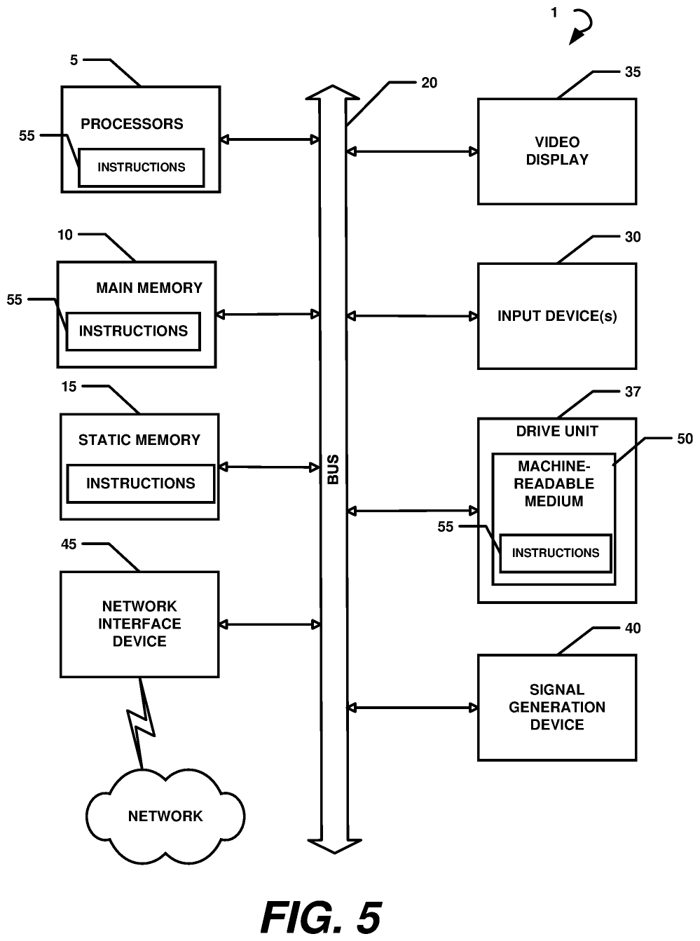

FIG. 5 is a diagrammatic representation of an example machine in the form of a computing device 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 1 includes a processor or multiple processors 5 (e.g., a central processing unit (CPU), a graphics processing unit (GPU), or both), and a main memory 10 and static memory 15, which communicate with each other via a bus 20. The computing device 1 may further include a video display 35 (e.g., a liquid crystal display (LCD)). The computing device 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computing device 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computing device 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read-only memory (ROM), and the like. The example embodiments described herein may be implemented in an operating environment comprising software installed on a computer, in hardware, or in a combination of software and hardware.

Not all components of the computing device 1 are required and thus portions of the computing device 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “engine”, “system”, “client”, “module”, “controller or microprocessor”, or “application” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Bolt”) may be interchangeably used with its non-capitalized version (e.g., “bolt”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, extrusion, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparent, luminescence, anti-reflection and/or holographic, a photo-sensitive coating, an electronic and/or thermal property coating, such as for passivity, insulation, resistance or conduction, a magnetic coating, a water-resistant and/or waterproof coating, and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below. Additionally, components described as being “first” or “second” can be interchanged with one another in their respective numbering unless clearly contradicted by the teachings herein.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

1. A system, comprising:
a communications interface configured to transmit data over a wireless connection using a wireless protocol having defined network limitations;
a processor; and
a memory for storing executable instructions, the processor executing the instructions to:
scale multi-touch input generated by a multi-touch device based on the network limitations; and
transmit the scaled multi-touch input to a computing device that is capable of being communicatively coupled to the processor through the communications interface;
wherein the wireless protocol having defined network limitations comprises Bluetooth or 2.4 GHz WiFi.

2. The system according to claim 1, further comprising the multi-touch device that generates multi-touch input corresponding to a plurality of touchpoints, wherein the multi-touch device is a trackpad or a touchpad.

3. The system according to claim 1, wherein the processor is further configured to:
scale the multi-touch input by selecting a refresh rate for receiving the multi-touch input based on the network limitations; and
multiplex the multi-touch input into a signal by placing the scaled multi-touch input into data packets, the signal comprising a human device interface (HID) protocol signal.

4. The system according to claim 1, wherein an operating system of the computing device does not identify the multi-touch device to be a mouse.

5. (canceled)

6. The system according to claim 1, further comprising a keyboard.

7. The system according to claim 1, wherein the processor is further configured to determine the network limitation, which comprises a defined packet size of data packets of the wireless connection.

8. The system according to claim 1, wherein the scaled multi-touch input are transmitted to a bus level of an operating system of the computing device.

9. A method, comprising:
scaling multi-touch input generated by a multi-touch device based on a packet size of data packets of a wireless protocol of a wireless connection;
assembling a multiplexed signal comprising the scaled multi-touch input; and
transmitting the multiplexed signal to a computing device through the wireless connection;
wherein the wireless protocol having defined network limitations comprises Bluetooth or 2.4 GHz WiFi.

10. The method according to claim 9, further comprising receiving the multi-touch input from the multi-touch device, the multi-touch input each comprising any of an X position of a finger, a Y position of the finger, a scan time value, an in range value, a width value, a height value, a confidence value, a left click indication, a right click indication, a pressure value, a barrel value, an X tilt value, a Y tilt value, an azimuth value, or any combinations thereof.

11. The method according to claim 9, wherein scaling the multi-touch input further comprises selecting a refresh rate for receiving the multi-touch input based on the packet size.

12. The method according to claim 9, wherein an operating system of the computing device does not recognize the multi-touch device as a mouse but as a trackpad or touchpad device.

13. (canceled)

14. The method according to claim 9, further comprising:
receiving a keyboard signal; and
integrating the keyboard signal into the multiplexed signal.

15. The method according to claim 9, further comprising determining the packet size of data packets of the multiplexed signal.

16. The method according to claim 9, wherein transmitting the multiplexed signal to the computing device comprises transmitting the assembled multiplexed signal to a bus level of an operating system of the computing device.

17. A method, comprising:
scaling a plurality of report inputs generated by a multi-touch device based on a packet size of data packets delivered through a human interface device (HID) protocol, the packet size being based on a wireless communications protocol of a wireless connection;
multiplexing the plurality of report inputs into the data packets of a single HID signal; and
transmitting the data packets of the single HID signal to an operating system over a wireless network connection using the wireless communications protocol wherein the wireless protocol having defined network limitations comprises Bluetooth or 2.4 GHz WiFi.

18. The method according to claim 17, further comprising receiving selections for customizable features of the multi-touch device, wherein the operating system applies the customizable features of the multi-touch device to on-screen actions in the opera ting system.

19. The method according to claim 18, wherein customizable features comprise any one or a combination of a pointer speed, a scrolling speed, a scrolling direction, or custom gestures.
